(19) United States
(12) Patent Application Publication
(10) Pub. No.: US 2009/0043515 A1
(43) Pub. Date: Feb. 12, 2009

(54) DIGITAL GAS DETECTOR AND NOISE REDUCTION TECHNIQUES

(76) Inventors: Mark K. Goldstein, Del Mar, CA (US); Eric Gonzales, Aurora, IL (US)

Correspondence Address: CHRISTIE, PARKER & HALE, LLP, PO BOX 7068, PASADENA, CA, 91109-7068, US

(21) Appl. No.: 12/254,799

(22) Filed: Oct. 20, 2008

Related U.S. Application Data
(62) Division of application No. 11/509,875, filed on Aug. 25, 2006, now abandoned.
(60) Provisional application No. 60/711,748, filed on Aug. 25, 2005.

(51) Int. Cl. G01N 31/00

(52) U.S. Cl. 702/24

(57) ABSTRACT

A sensor apparatus incorporates a responding gas sensor to measure and display gas concentrations or other indications. Calculation of a gas concentration may be derived from an output signal of a light detector through the use of a linear equation. Through the use of digital processing an output signal may be sampled to calculate a gas concentration based on a rate of change of the output voltage.

### CROSS-REFERENCE TO RELATED APPLICATION(S)

This U.S. patent application is a divisional of U.S. patent application Ser. No. 11/509,875, filed Aug. 25, 2006 which claims the benefit of U.S. Provisional Patent Application No. 60/711,748, filed Aug. 25, 2005, the disclosure of which is hereby incorporated by reference herein.

### TECHNICAL FIELD

This application relates to sensors and, more specifically, to a gas sensor that incorporates digital circuitry that is adapted to process sensed signals to generate a reliable gas sense indication and to noise reduction techniques for a sensing device.

### BACKGROUND

Increased public awareness of the harmful effects and dangers of hazardous gases in the air has resulted in a growing demand for accurate, inexpensive, and compact devices that detect such gases. Conventional battery operated, portable gas detection devices incorporate sensors to detect the gas of interest.

A variety of optical gas sensors for detecting the presence of hazardous gases, especially carbon monoxide (“CO”), are known. Exemplary optical gas sensors are described in U.S. Pat. Nos. 5,063,164; 5,302,350; 5,346,671; 5,405,583; 5,618,493; 5,793,295; 6,172,759; 6,251,344 and 6,819,811, the disclosure of each of which is hereby incorporated by reference. An improved optical gas sensor system has been made by optically combining gas sensors having a response over a wide range of humidity and temperature conditions as disclosed in U.S. Pat. No. 5,618,493.

Generally, optical gas sensors include a self-regenerating, chemical sensor reagent impregnated into or coated onto a semi-transparent substrate. The substrate is typically a porous monolithic material, such as silicon dioxide, aluminum oxide, aluminosilicates, etc. Upon exposure to a predetermined target gas, the optical characteristics of the sensor change, either darkening or lightening depending on the chemistry of the sensor.

Battery powered, target gas detection devices utilizing optical gas sensors are commercially available and have met with great market success. Conventionally, such devices include at least one sensor placed in a light path between a light emitting means and a light detecting means. The light detecting means monitors the optical characteristics of the sensor by measuring the level of light transmitted through the sensor. Electronic components of the device are devised so that when the detected level of transmitted light falls below a predetermined fixed level, an alarm or other warning means is activated.

In a typical device, the electronic components include a capacitor that is charged by current flowing through the light detecting means. Here, the amount of current flowing through the capacitor depends on the optical characteristics of the sensor. Thus, the speed at which the capacitor charges depends on the concentration levels of the target gas that interacts with the sensor. To determine the concentration level, the device may, for example, discharge the capacitor then keep track of the time it takes for the capacitor to charge. To this end, the device may include a processing component that includes a clock circuit (e.g., a crystal-based oscillator) for timing operations and a level detection circuit for detecting when the capacitor is charged. Devices such as these are described, for example, in U.S. Pat. Nos. 5,573,953 and 6,096,560, the disclosure of each of which is hereby incorporated by reference.

In general, the characteristics of the electronic components may have an adverse effect on the accuracy of the device. For example, the actual capacitance value for a given capacitor may not be precise. Rather, capacitors are typically characterized by a nominal capacitance value such that the actual capacitance will fall within a tolerance range around the nominal value. As a result, the capacitor in one device may charge at a different rate than the capacitor in another device. In addition, a crystal oscillator may not operate precisely at its specified nominal frequency. As a result, the timer circuit in one device may count faster or slower than a timer circuit in another device. Also, process variations that occur when manufacturing the processing component may result in the level detection circuits of different devices having slightly different threshold levels and/or leakage current. Consequently, different devices may make the determination that a capacitor is charged at different voltage levels. Moreover, many of these parameters may be temperature dependent. In view of problems such as these, a need exists for a more accurate, yet cost-effective device for sensing gas concentrations.

### SUMMARY OF THE INVENTION

The invention relates in some embodiments to a gas sensor that incorporates linear and/or digital processing to identify gas concentrations. The invention relates in some embodiments to an apparatus and method for reducing noise in a sensing device, thereby improving the signal-to-noise ratio of signals generated by the sensing device. For convenience, an embodiment of a system constructed or a method practiced according to the invention may be referred to herein simply as an “embodiment.”

In some embodiments calculation of a gas concentration may be derived from an output signal of a light detector through the use of a linear equation. For example, using a sensor with an exponential-based gas diffusion characteristic and a photodiode with a logarithmic light to current characteristic, a linear equation may be used to relate a gas concentration with output voltages derived from the photodiode current.

In some embodiments the linear equation may be used to derive a particular concentration level from a particular rate of change of output voltage. In some embodiments one or more predefined multipliers may be assigned to different ranges of the output voltage. For example, a different multiplier may be defined for the linear equation for each range.

In some embodiments a sensor comprises an LED for generating light, a sensor exposed to a surrounding environment and a photodiode for sensing light. The components are positioned so that light from the LED may pass through the sensor to the photodiode. In this way, the photodiode may detect changes in the light diffusion properties (e.g., the light transmittance value) of the sensor caused by changes in a concentration level of a gas in the surrounding environment.

In some embodiments the current output of the photodiode is provided to a current to voltage converter. The output of the current to voltage converter may then be provided to an analog to digital converter. A processing component such as a microcontroller may then read the voltage levels provided by the analog to digital converter to determine rates of change in the voltage. Using linear techniques, the processing component may then determine the concentration level of the gas from the changes in voltage. The processing components may generate appropriate indications (e.g., display a gas concentration level or generate an alarm signal) relating to the current gas concentration level. Here, alarm conditions may be indicated by comparison of the measured concentration with predefined concentration levels.

In some embodiments, predefined multipliers for the linear equations may be obtained from empirical data. For example, rates of change in output voltage with respect to output voltage may be determined for various known gas concentration levels and temperatures. From this data the relationship, at various output voltages, between gas concentration and slope (V/Hr) for the different temperatures may be calculated. From this, the multipliers for various ranges of the output voltage may then be determined. Here, a different set of multipliers may be applicable to different temperatures.

In some embodiments a sensor may be calibrated by adjusting the linear equations. For example, a difference between a concentration reading provided by a device and a known concentration level may be used to configure the device to compensate for the reading. In some embodiments this compensation factor may comprise a sub-multiplier for the multiplier for the linear equation. In some embodiments the compensation factor may be stored in a non-volatile memory in the device.

Some embodiments relate to an apparatus and method for improving the signal-to-noise ratio of signals generated by the sensing device. For example, the apparatus may be designed to reduce interference and noise associated with the sensing device.

### BRIEF DESCRIPTION OF THE DRAWINGS

These and other features, aspects and advantages of the present invention will be more fully understood when considered with respect to the following detailed description, appended claims and accompanying drawings, wherein:

FIG. 1 is a simplified block diagram of one embodiment of a sensor device constructed in accordance with the invention;

FIG. 2 is a simplified graph illustrating one example of a relationship between an output voltage and time;

FIG. 3 is a flow chart of one embodiment of gas concentration detection operations that may be performed in accordance with the invention;

FIG. 4 is a simplified block and circuit diagram of one embodiment of a sensor device constructed in accordance with the invention;

FIG. 5 is a flow chart of one embodiment of initialization, configuration and calibration operations that may be performed in accordance with the invention;

FIG. 6 is a flow chart of one embodiment of gas concentration detection operations that may be performed in accordance with the invention;

FIG. 7 is a simplified graph illustrating one example of a relationship between rate of change in output voltage and output voltage;

FIG. 8 is a simplified graph illustrating one example of a relationship between gas concentration and slope for various temperatures;

FIG. 9 is a simplified graph illustrating one example of relationships between gas concentration and slope for various output voltages;

FIG. 10 is a simplified diagram of one embodiment of a sensor device constructed in accordance with the invention;

FIG. 11 illustrates one embodiment of the use sensor elements in a combined CO and smoke detector, which enhances early fire detection by cross fertilization from one sensor to increase the sensitivity of the other; and

FIG. 12 is a simplified schematic diagram of one embodiment of a fire detector comprising multiple combined sensors, i.e., CO, RH, T and Smoke and/or ions.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus or method. Finally, like reference numerals denote like features throughout the specification and figures.

### DETAILED DESCRIPTION OF THE INVENTION

The invention is described below, with reference to detailed illustrative embodiments. It will be apparent that the invention may be embodied in a wide variety of forms, some of which may be quite different from those of the disclosed embodiments. Consequently, the specific structural and functional details disclosed herein are merely representative and do not limit the scope of the invention.

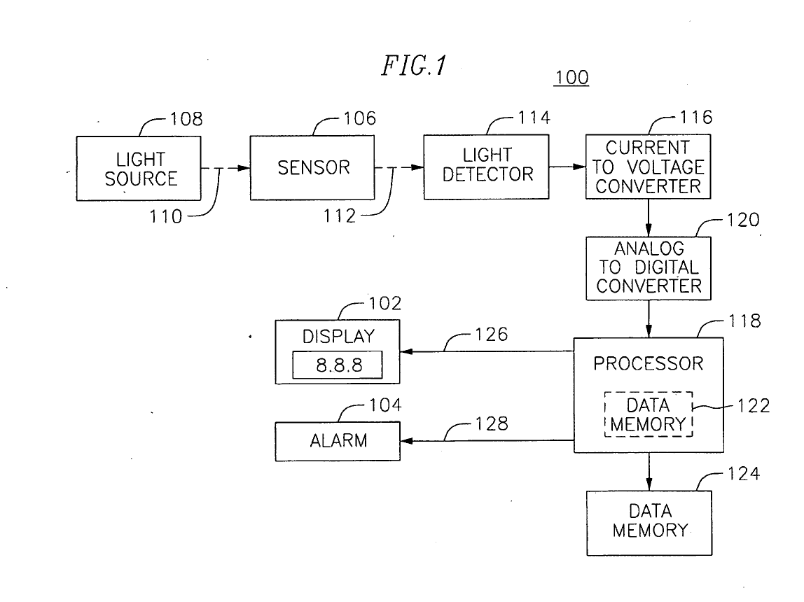

FIG. 1 is a simplified block diagram of one embodiment of a gas sensor apparatus 100. The apparatus 100 generates indications such as characters on a display 102 or alarm signals that may drive an alarm (e.g., a siren) 104 in accordance with a concentration level of a target gas in the proximity of a sensor 106. Here, the sensor 106 may be a biomimetic sensor whereby the light transmission characteristics of the sensor depend on the concentration level of the gas in the air surrounding the sensor.

Detection circuitry in the apparatus generates an output signal wherein the magnitude of the output signal depends on the concentration of the gas. For example, a light source 108 generates light (represented by dashed line 110) that passes through the sensor 106. Light (represented by dashed line 112) emanating from the sensor 106 is detected by a light detector 114. In some embodiments the light detector 114 generates a current signal that may be converted to a voltage signal by a current to voltage converter 116.

In some embodiments an analog to digital converter 120 may be used to convert the output signal (current or voltage) to a digital signal. Alternatively, the analog to digital conversion may be performed by circuitry in a processor 118 (e.g., a microcontroller).

In any event, the output signal is processed by the processor 118 that is configured to calculate the concentration of the gas based on the output signal. In some embodiments this calculation may be based on a linear equation. For example, the gas diffusion characteristics of some sensors may be described by an exponential equation of the form e^{COK} where CO represents the gas concentration and K represents a constant. In addition, the output characteristics of some light detectors are logarithmic in nature. Consequently, the output of a light detector may be related back to the gas concentration by a linear equation since log(e^{COK}) equates to K1COK.

In some embodiments, a linear equation that may be used to calculate the gas concentration from the output voltage is of the form:

CO=M(ΔV/Hr)+k EQUATION 1

where
CO is the gas concentration,
M is a multiplier,
ΔV/Hr is the change in output voltage per hour, and
k is a constant.

Through the use of relatively simple linear equations, the complexity of the gas concentration calculation may be significantly reduced in comparison to conventional techniques. Such simplification may be achieved in this embodiment because the calculations may involve relative few table look-ups and/or relatively simple mathematical operations. For example, the desired slope may be obtained relatively quickly using two sample points. In addition, Equation 1 only involves one multiply, one divide and one add. In contrast, conventional capacitor-based techniques involve the calculation of quantities dependent on 1/i where i is the current though the capacitor. These forms of calculations may be either relatively complex and/or involve the use of relatively large look-up tables.

The processor 118 may be associated with one or more data memories 122 and 124. A data memory may comprises volatile memory (e.g., RAM) or non-volatile memory (e.g., ROM, flash memory). A data memory may be used to store, for example, program code, one or more multipliers or constant parameters, calibration data, alarm thresholds, etc. A data memory (e.g., memory 122) may be a component of the processor 118 or separate from the processor 118 (e.g., memory 124).

The processor 118 generates one or more signals (e.g., as represented by lines 126 and 128) that may be indicative of gas concentration calculated by the processor 118. For example, the processor 118 may send messages to the display 102 that cause the display 102 to display, for example, the current concentration level, a warning indication, etc. The processor also may send a signal that causes the alarm 104 to generate an alarm indication (e.g., a siren tone).

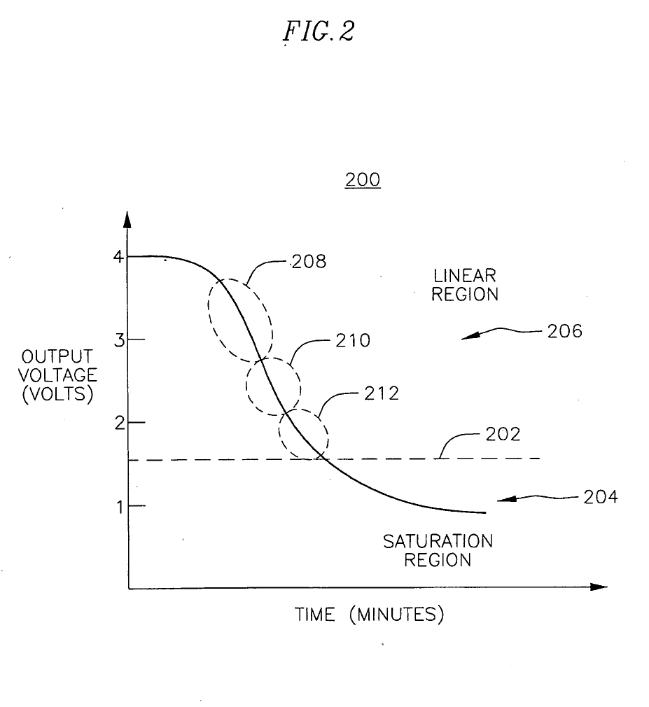

FIG. 2 is a graph 200 that illustrates an example of a relationship of output voltage to time when the apparatus is subjected to a given concentration of gas. In this example, the output voltage decreases over time as the gas infuses into the sensor. Here, the infusion of the gas causes the sensor to “darken” thereby reducing the amount of current generated by the light detector.

The graph 200 is divided into two regions by a horizontal line 202. A saturation region 204 below the line represents a region where the light detector may saturate. In this case, the readings from the sensor may be unreliable and the sensor may need to be subjected to fresh air to regenerate the sensor. Alternatively, the region below the line 202 may represent a region where the relative change in output voltage is too small to provide accurate results given the particular resolution of the analog to digital converter.

A linear region 206 above the line represents a region where the output voltage may exhibit linear or substantially linear characteristics. In some embodiments, the linear region may be subdivided into multiple linear sub-regions. For example, each of the sub-regions 208, 210 and 212 may be described or approximated by a linear equation. Different linear equations may be required because the slope of the curve changes over time. This change in slope is the result of the longer path the gas takes as it infuses further and further into the sensor. In other words, it is more difficult for the gas to pass into the middle of the sensor than it is for the gas to pass into the outer portion of the sensor.

Each of these sub-regions may, in turn, be associated with a particular range of the output voltage. For example, in one embodiment the range 1.5V to 2.0 V may be related to sub-region 212, the range 2.0V to 2.5V may be related to sub-region 210, and the range “greater than 2.5V” may be related to sub-region 208.

Of note, each linear equation has a different slope. Accordingly, the slope for each region may be used in Equation 1 to calculate the gas concentration associated with a rate of change of the output voltage when the output voltage is within a particular range. As discussed in more detail below, the slope of each of the linear equations may be calculated by, for example, collecting and analyzing data relating to the output voltage under various controlled conditions.

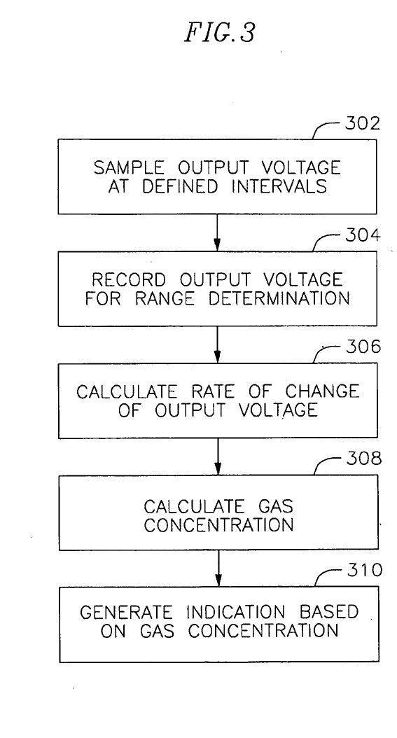

A simplified example of operations that may be performed by the apparatus 100 will be treated in conjunction with the flowchart of FIG. 3. Initially, as represented by block 302, the apparatus samples the value of the output voltage at regular intervals.

As represented by block 304, in conjunction with the sampling, the value of the output voltage may be recorded. This step may be performed, for example, to determine the appropriate value of the multiplier M that will be used in Equation 1 below.

After sampling a desired amount of data, the apparatus calculates the rate of change of the output voltage (block 306). In some embodiments, this value may be converted to correspond to a change in voltage per hour (ΔV/Hr).

As represented by block 308, the gas concentration is calculated using Equation 1. In some embodiments, the values for the predefined parameters M and k in Equation 1 may be stored in a table in a data memory. Here, a value for M and, perhaps, k may be stored for various ranges of the output voltage. Accordingly, this operation may involve determining the appropriate range using the value of the output voltage recorded at block 304. The corresponding parameter(s) are then retrieved from the data memory and used in Equation 1 together with the ΔV/Hr value calculated at block 306.

The sensor apparatus may then generate some form of signal corresponding to the calculated gas concentration (block 310). For example, in some embodiments the display apparatus may display the value of the gas concentration (e.g., in ppm). In some embodiments the sensor apparatus may generate a display that indicates whether the gas concentration is acceptable (e.g., display: “OK”) or not acceptable (e.g., display a warning message) based on a predefined threshold value. In some embodiments the sensor apparatus may generate one or more other signals relating to the gas concentration. For example, when the gas concentration exceeds the predefined threshold, an appropriate signal may be sent to an audible or visual warning device such as a strobe light or a siren (or similar tone generator). Alternatively, a signal may be sent to another component (e.g., a security console) via, for example, a wired or wireless connection.

The disclosed methods and structure for measuring and displaying gas concentrations may provide more accurate measurements through the use of the relatively simple calculations and/or digital techniques. In addition, these methods and structures may provide a more direct method of determining the end-of life for a sensor. Moreover, a sensor constructed and operated as described herein may provide, for example, accuracy within one percent at room temperature and better than five percent over a range of −40° C. to 70° C.

The sensor apparatus may provide improved accuracy over conventional sensors, in part, because the accuracy of the concentration measurement is based on the values of the resistors in the apparatus. Here, resistors with tolerances of 1% or better may be incorporated into the system at a relatively low cost. Moreover, the resistance value of resistors may be relatively stable even when the resistors are subjected to changes in temperature.

With the above overview in mind, additional details of a sensor system will be described as implemented in a carbon monoxide (“CO”) sensor apparatus. The described CO apparatus is but one example of an apparatus that may incorporate the teaching herein. Accordingly, it should be understood that the teachings herein may be applicable to a variety of other types of gas sensors.

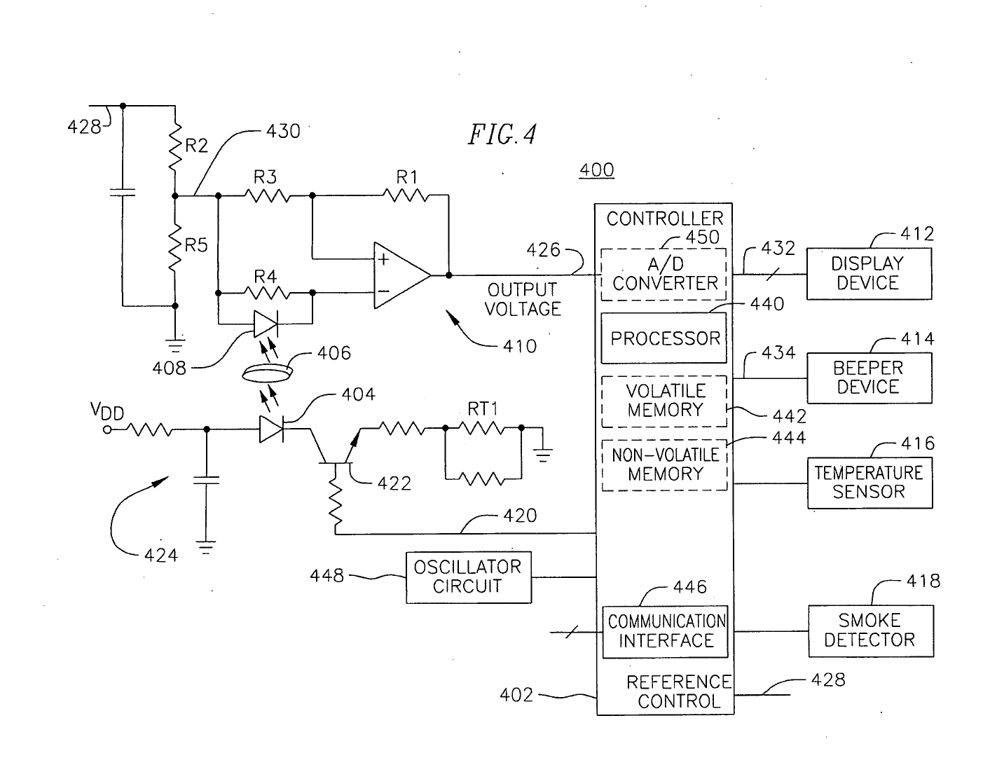

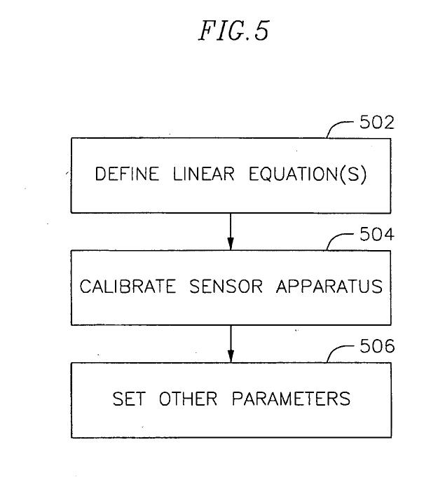

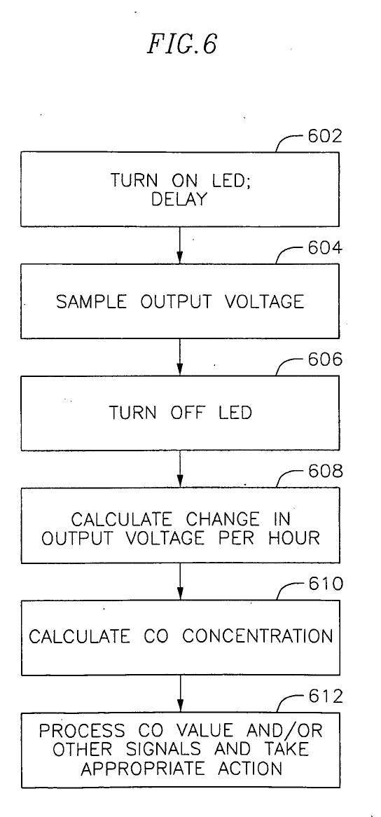

FIG. 4 is a simplified schematic and block diagram of one embodiment of a sensor apparatus 400 that calculates the concentration of CO in the vicinity of a sensor and generates indications (e.g., tangible output events) relating to the calculated CO concentration. FIGS. 5 and 6 are simplified flowcharts illustrating operations that may be performed in conjunction with or by a sensor apparatus such as the apparatus 400.

The apparatus 400 includes a controller 402 (e.g., a computing system including a processor 440 and peripheral components), an LED 404, a sensor 406, a photodiode 408, an operational amplifier circuit 410, a display device 412, a beeper device 414, an optional temperature sensor 416 and an optional smoke detector 418.

The controller 402 controls the sensing and reporting operations of the apparatus. As illustrated in FIG. 4, in some embodiments the data memories 442 and 444 associated with the controller may be implemented within the controller 402. The controller 402 provides one or more communication interfaces 446 that may be used to program, reconfigure, debug or otherwise communicate with the apparatus. As in conventional processing systems, an oscillator circuit 448 such as a crystal or a resonator provides a clock signal for the controller 402. The controller 402 also provides various input ports and output ports for receiving signals from and sending signal to the other components of the apparatus. These signals will be discussed in more detail below in conjunction with the corresponding components.

In some embodiments the controller 402 may control the operation of the LED 404. For example, the controller 402 may generate a signal 420 that either turns the LED 404 ON or turns the LED 404 OFF. In the embodiment of FIG. 4 this is accomplished by turning ON and OFF a transistor 422 in a bias circuit 424 for the LED 404.

The bias circuit 424 may be used to bias the photodiode 404 to provide the desired linear response. For example, in some embodiments the photodiode 404 may be biased and configured to effectively operate in a range of approximately 1 to 4 volts. Here, 4 volts may represent the zero of the circuit and 1 volt may represent the range limit.

In other embodiments the controller 402 may adjust the amount of current that flows through the LED 404. For example, the signal 420 may comprise a non-digital signal that controls the amount of current flow through the transistor (and hence though the LED bias circuit). Alternatively, the controller 402 may have several output ports that control the LED current via a resistor network or other circuit (not shown).

The operational amplifier circuit 410 generates an output voltage signal 426 that corresponds to the magnitude of the current flow through the photodiode 408. Here, the photodiode current flows through resistor R4 which causes the operational amplifier circuit 410 to generate, for example, a proportional output voltage signal 426.

In some embodiments a reference voltage signal 430 may be provided to the operational amplifier circuit 410. In the embodiment of FIG. 4, the reference voltage signal 430 may be controlled by a signal 428 from the controller 402. As discussed above, the reference voltage may be use to establish a maximum value (e.g., 4V) for the output voltage 426. The maximum voltage may be selected to provide sufficient margin and range for the output voltage 426. In some embodiments, the sensor apparatus 400 may be configured to provide an output voltage of 4V when the gas concentration level is at 0 ppm.

The output voltage signal 426 is provided to the controller 402. In the embodiment of FIG. 4, the controller 402 incorporates an analog to digital converter 450 that converts the output voltage signal 426 to a digital signal (not shown in FIG. 4).

One or more output signals 432 from the controller 402 control the display device 412. Thus, through appropriate programming the controller 402 may cause the display device 412 to display a desired message or other indication.

Another output signal 434 controls the operation of the beeper device 414. Thus, when the measured CO concentration exceeds a threshold level, the controller may cause the beeper device 414 to generate an audible alarm.

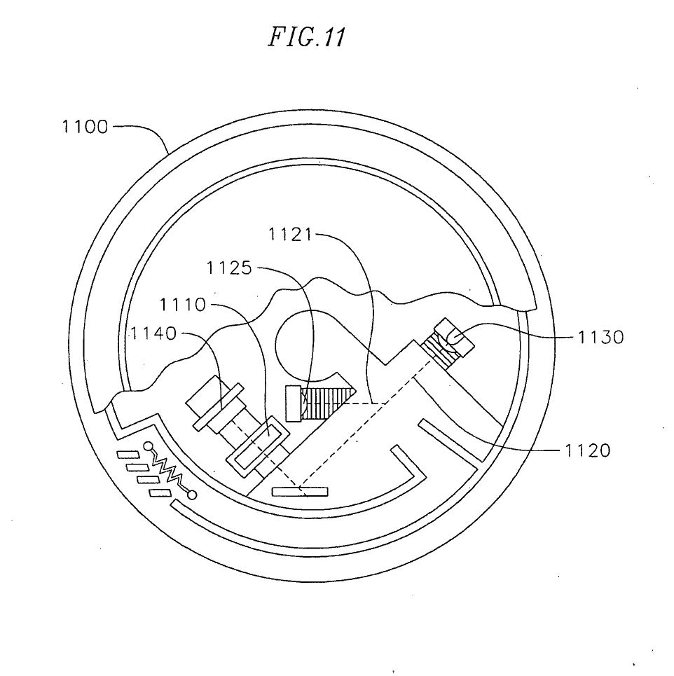

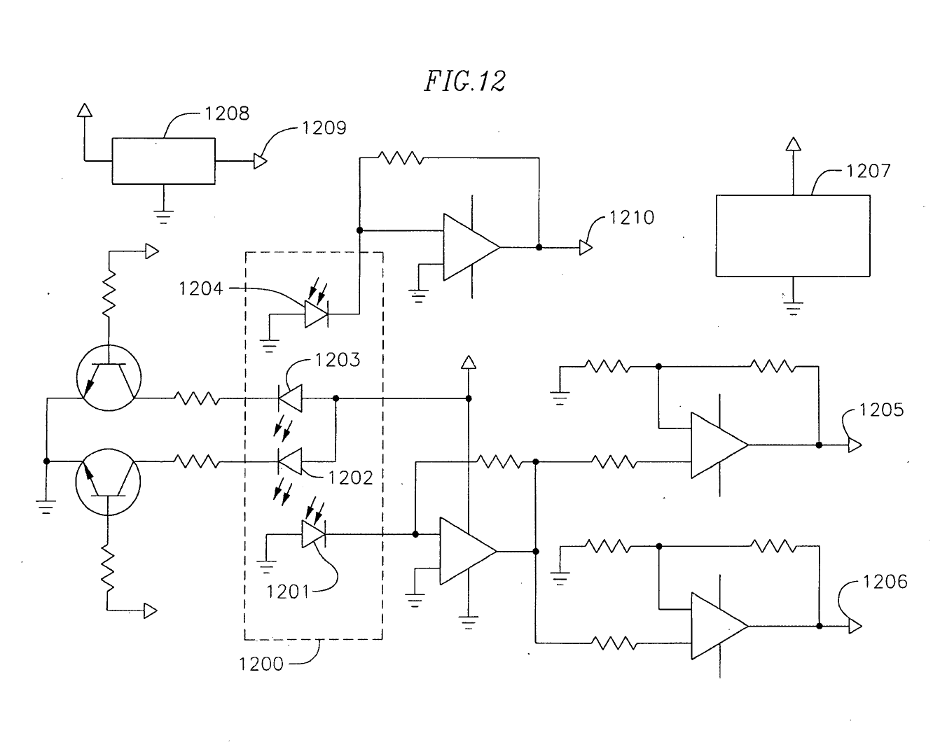

In some embodiments the CO sense operations may operate in conjunction with or in addition to other sense operations. For example, the temperature sensor 416 may be used to provide temperature information to the controller 402. In addition, the smoke detector 418 may be used to provide an indication to the controller as to the presence of smoke and, in some applications, the nature and/or density of the smoke. One embodiment of such a sensor apparatus is described in more detail in conjunction with FIGS. 11 and 12.

A simplified example of operations that may be performed by a sensor apparatus such as the apparatus 400 will be described in conjunction with the flowcharts of FIGS. 5 and 6. FIG. 5 illustrates various operations that may be used to initialize, configure and calibrate a sensor apparatus. FIG. 6 illustrates various operations that may be used to measure CO concentration levels and perform various operations based on the measure CO level and/or other signals.

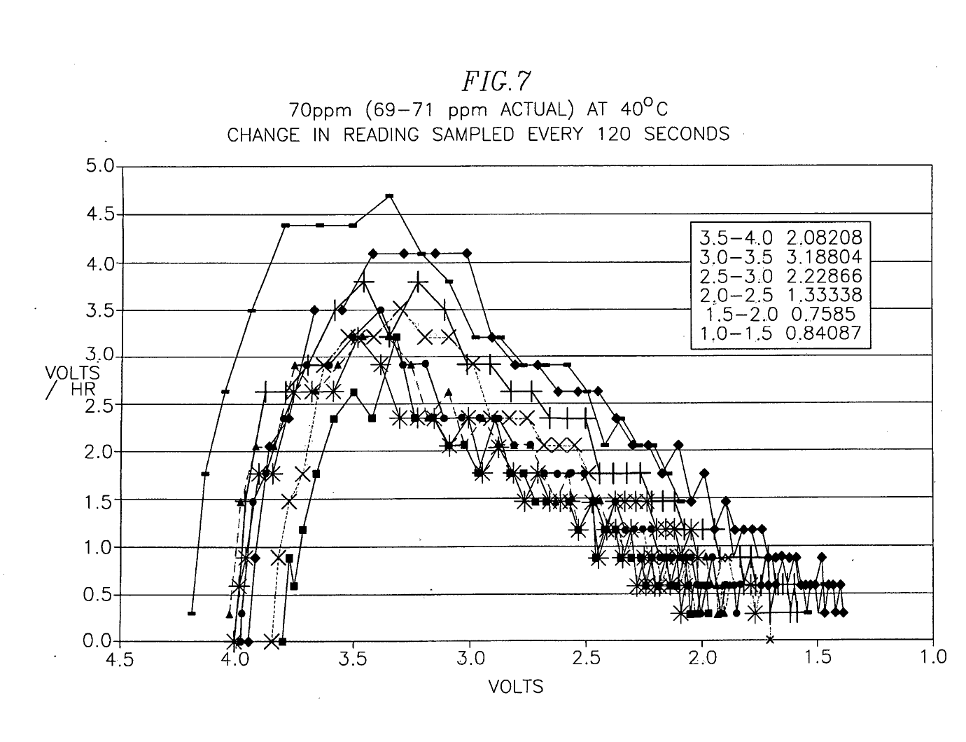

Referring to FIG. 5, as represented by block 502, the linear equations for the concentration calculation are defined. As discussed above, in some embodiments this involves generating different equations for different ranges (e.g., the sub-regions of FIG. 2) of the output voltage. One embodiment of a process for generating the linear equations may be better understood by reference to FIGS. 7, 8 and 9.

FIG. 7 illustrates, in graphic form, one example of rate of change of the output voltage (ΔVolts/Hour) versus output voltage (Volts). A collection of data points such as the one represented by FIG. 7 is generated for a variety of gas concentrations and temperatures. For example, the apparatus may be placed in a controlled environment where the gas concentration and temperature may be set and tightly regulated. In one embodiment, measurements are made at gas concentrations of 70 ppm, 150 ppm, 250 ppm and 450 ppm. In addition, for each of these concentration levels, measurements are made at temperatures of −40° C., 0° C., 25° C., 40° C. and 70° C.

A change in the output voltage reading may then be recorded at a given interval (e.g., every 120 seconds). This process also may be performed using several different sensor apparatuses to obtain a statistically reliable amount of data.

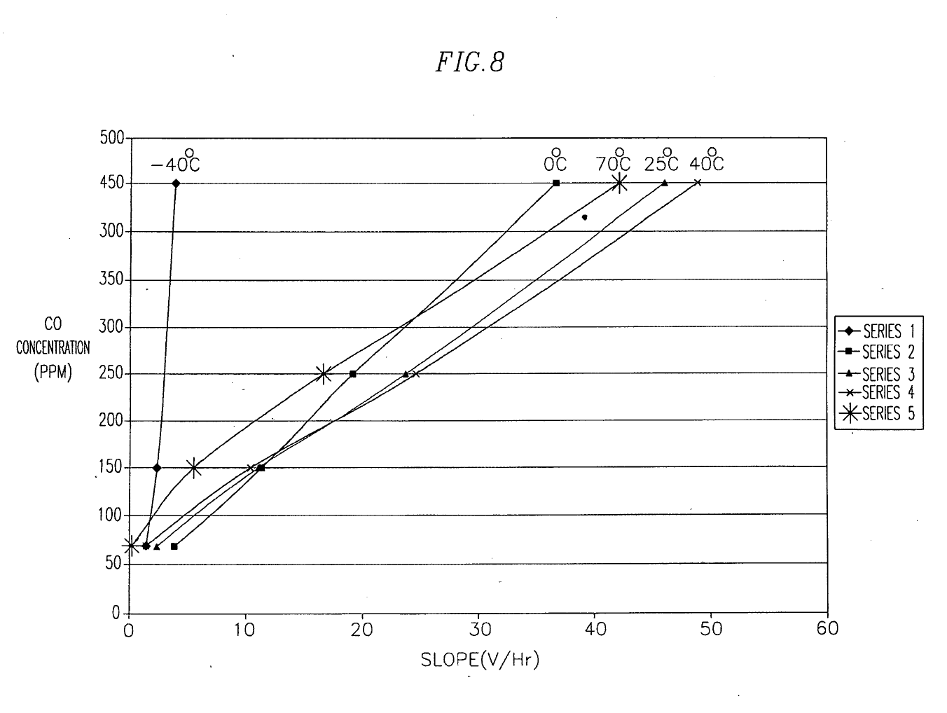

From this collection of data, relationships such as those represented in FIG. 8 may be calculated. FIG. 8 depicts, in graphical form, gas concentration (PPM) versus slope (ΔVolts/Hour) of the output voltage for a given output voltage (e.g., 2.5V). Here, a separate line is defined for each temperature. The lines in FIG. 8 serve to illustrate that the relationship between the gas concentration and slope is linear or substantially linear over a significant range of values. The data points shown in FIG. 8 may therefore be used to define a linear equation that fairly accurately relates a change in output voltage with a gas concentration.

A collection of data such as the one represented by FIG. 8 may be calculated for various output voltage levels. In one embodiment, data is collected for output voltages of 1.5V, 2.0V, 2.5V, 3.0V and 3.5V in an apparatus with an upper output range of 4V (e.g., as illustrated in FIG. 2). These charts serve to illustrate that for certain ranges of temperatures, the slopes of the lines (e.g., the linear equations for this output voltage) may be the same or substantially the same.

In addition, from this collection of data, slope compensation data may be derived that may be used to adjust the slope of the linear equation when operating at other temperatures (e.g., 0° C.). For example, the sensor apparatus may measure the ambient temperature and use an appropriate algorithm to adjust for any changes in slope related to temperature.

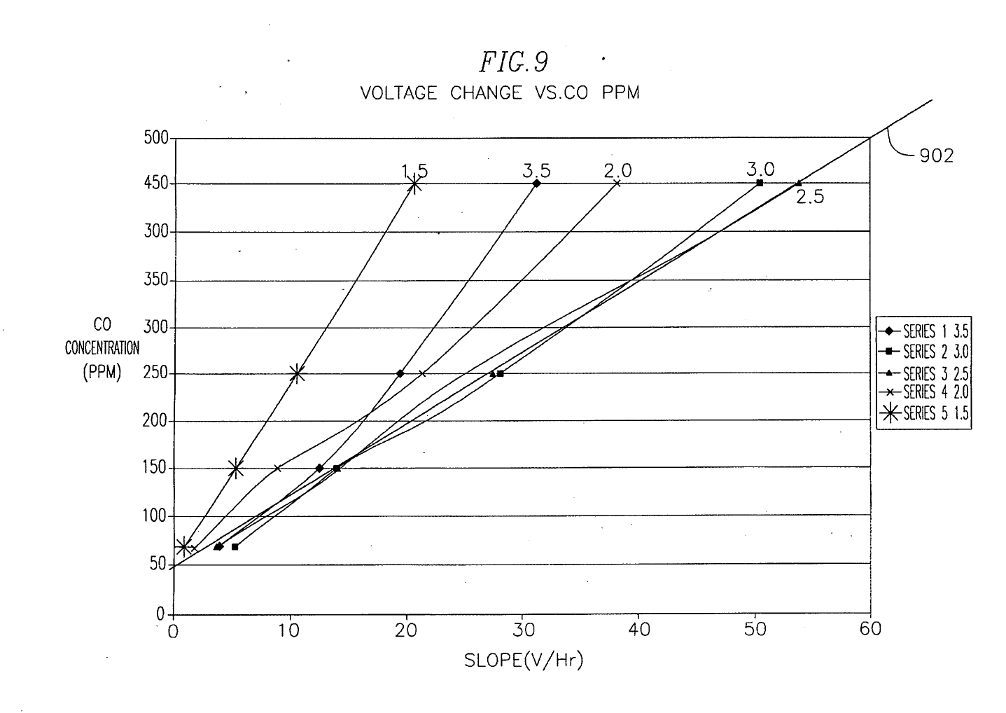

FIG. 9 illustrates, in graphical form, similarities and differences in the slopes of the linear equations associated with various output voltages at a given temperature (e.g., 25° C.). For example, it may be observed that the slopes of the lines for 2.5V and 3.0V are similar. Conversely, it may be observed that the slopes for 2.0V and 1.5V differ significantly for the other slopes.

The above relationships illustrate that the parameters (e.g., M and k) needed for Equation 1 may be derived from the above collections of data. In addition, given that different slopes apply to different ranges of the output voltage, a separate set of parameters may be derived for each range.

An example of how to derive the parameters follows. Initially, a decision may be made (by analyzing the collected data) as to which ranges of output voltage have similar slopes. An approximation may then be made from the collection of data that corresponds to each range to define a single linear equation for each range. For example, as shown in FIG. 9, a line 902 may be defined that runs between the lines for 2.5V and 3.0V. In other words, line 902 may represent the average of the two slopes.

The slope of the line 902 may then be calculated from the data points. For example, a change in concentration from 450 to 50 ppm corresponds to a change in slope from 53.5 to 0. The slope of the line is thus 7.4766. The y-intersect of the line is 50 ppm. Accordingly, the linear equation for line 902 is PPM 7.4766-slope+50. Rearranging for Equation 1 (where ΔV/Hr is the variable) provides:

CO=7.4766(ΔV/Hr)+50 EQUATION 2

Similar slopes may then be calculated for other ranges of the output voltage. For example, Table 1 describes one example of the values for M for various ranges of the output voltage (Vt).

TABLE 1

| Vₜ | M |
|---|---|
| <1.5 V | Saturation |
| 1.5 V-2.0 V | −17.2 Vₜ + 44.8 |
| 2.0 V-2.5 V | −5.4 Vₜ + 21 |
| >2.5 V | 7.6 |

As discussed above, at some level of the output voltage, the photodiode may be saturated. At this point, the concentration level may, for example, be assumed to be the value that was measured before the output voltage reached the saturation level (e.g., 1.5V).

It should be appreciated that the relationships and calculations discussed above are described in graph form for purposes of explanation. In practice, the necessary calculations may be performed on the raw data. That is, graphs do not need to be generated to derive the desired parameters.

Referring again to FIG. 5, as represented by block 504, each apparatus may be calibrated. For example, the apparatus may be placed in a controlled environment where the gas concentration and the temperature may be set and maintained at known values. The gas concentration displayed by the sensor apparatus may then be compared with the actual value. If there is a difference, a compensation parameter (e.g. m) may be calculated and stored in nonvolatile memory in the sensor apparatus. When such a parameter is stored in the nonvolatile memory, Equation 1 may be modified as follows:

CO=Mm(ΔV/Hr)+k EQUATION 3

In some embodiments the parameter m is a corrective multiplier that represents a percentage of how fast the sensor is as compared to the average for a sensor. For example, m may be set to 1 for a sensor that has an average response time. The parameter m may be set to 1.1 for a sensor that is slower than average. The parameter m may be set to 0.9 for a sensor that is faster than average.

In the event the sensor apparatus may not be adjusted (e.g., calibrated) to display, within a desired tolerance, the correct value, the sensor and/or the sensor apparatus may be rejected. For example, the part may be repaired, discarded or used in applications that need less accurate measurements.

As represented by block 506, other parameters associated with the sensor apparatus may be set when the apparatus is manufactured or adjusted at some later time. For example, the controller may control the current through the LED by adjusting the output signal 420. Since this current controls the amount of light generated by the LED, this current may be controlled, for example, to compensate for the characteristics of the filter and/or to adjust the output response of the photodiode.

In addition, the processor may control a reference level for the output voltage by adjusting the signal 430. In the example of FIG. 2, the reference level is set to 4V. The 4V level may be used, for example, in a sensor apparatus that has a power supply voltage of 5V. In this case, the output voltage may be constrained to a maximum of 4V. This may provide sufficient margin in the event of a drop in the power supply voltage while still providing a relatively large range of values for the output voltage.

Referring now to FIG. 6, one embodiment of operations that may be performed by a sensor apparatus will be discussed in more detail. These operations may include, for example, measuring CO concentration, generating indications regarding the measured concentrations, detecting sensor end-of-life, etc.

Initially, at block 602, the controller turns on the LED and delays a prescribed period of time (e.g., 50 μS) before taking any readings. This delay may serve to ensure that the detection circuits are relatively stable.

At block 604 the controller repetitively reads the value output by the analog to digital converter. Here, the output of the analog to digital converter is the digitized form of the output voltage (e.g., signal 426). The value is read at regular intervals corresponding to Δt discussed above.

In some embodiments the value of Δt may be set depending on the measured (or a previously measured) rate of change in the output voltage. For example, if the voltage change per hour (hereafter referred to as “VCH” for convenience) is less than 10, Δt may be set to 120 seconds. Alternatively, if the voltage change per hour is greater than 10, Δt may be set to 20 seconds.

In some embodiments the readings may be processed in an attempt to improve the accuracy of the readings. For example, for every reading four data points may be accumulated and averaged. These data points may be taken, for example, every Δinterval. In some embodiments the Δinterval may initially be set to 5 mS. The highest and lowest values may then be discarded.

At block 606, the controller turns off the LED after the desired number of readings have been taken. At this point, the data read above will have been stored in a data memory for use in the operations that follow.

At block 608, the most recent reading or the output voltage Vt is subtracted from the previous value taken (e.g., Vt-Δt). This difference may be multiplied by 3600 to convert the result to hours. This product may then be divided by Δt to provide the slope in VCH. In other words, the following equation may be used to calculate the change in voltage per hour when sampling over a period of 120 seconds:

VCH=[(Vₜ−V_{t-Δt})/120 seconds]·3600 EQUATION 4

At block 610, the controller calculates the CO concentration in accordance with Equation 1 (e.g., using Equation 4 in this example). As discussed above, the parameters M and k may be obtained, for example, from a table (e.g., Table 1) stored in data memory. Here, the value of M is obtained from the table using the value of Vt referred to at block 608.

At block 612, the controller processes the calculated CO value and/or other signals and takes the appropriate action. For example, in some embodiments the controller may generate signals that cause the display device 412 to display the computed value of the CO concentration (e.g., in ppm).

In some embodiments various criteria may be established to determine when a value of 0 ppm is displayed by the sensor apparatus. For example, 0 ppm may be displayed when VCH is less than −1V/Hr. In addition, 0 ppm may be displayed when Vt is greater than the voltage where VCH was first measured to exceed 1 V/Hr.

In some embodiments, when the displayed value is not 0 ppm and the conditions for 0 ppm are not satisfied, and VCH<1 V/Hr, the sensor apparatus displays the previously computed CO concentration value.

Alternatively, when the displayed value is 0 ppm, the sensor apparatus will continue to display this value until VCH>2V/H. In some embodiments VCH>2V/H relates to the condition for 70 ppm.

The controller may compare the CO value with one or more thresholds. For example, the CO value may be compared with a threshold that indicates whether an alarm condition exists.

In some embodiments alarm conditions (e.g., thresholds) are defined as follows. The time-to-alarm (in seconds) may be calculated using the formula “24·PPM-1280” when the CO concentration (PPM) is 70 ppm to 150 ppm. The time-to-alarm may be calculated using the formula “18·PPM-456” when the CO concentration (PPM) is 150 ppm and above.

In some embodiments an alarm condition is reached when an alarm count reaches 800 hexadecimal. Here, the value of the alarm count may be incremented by an alarm increment every Δt. The alarm increment may be, for example, time-to alarm·Δt/1000.

In some embodiments the alarm increment is computed to pass UL alarm time requirements. For example, for a CO concentration of 70 ppm+/−5 ppm the alarm time is 60 to 240 minutes. For a CO concentration of 150 ppm+/−5 ppm the alarm time is 10 to 50 minutes. For a CO concentration of 400 ppm+/−10 ppm the alarm time is 4 to 15 minutes.

In some embodiments, alarm conditions may be generated in accordance with techniques described in U.S. Pat. No. 5,624,848. The disclosure of this patent is hereby incorporated by reference.

When an alarm is to be activated, the controller generates the appropriate signal(s) to activate, for example, the beeper device and/or the display device. In some embodiments an additional alarm indication (e.g., display: “GET OUT”) may be provided 20 minutes after the alarm condition is reached in the event saturation (e.g., Vt<1.5V) also is reached.

In some embodiments the controller may process the CO value and/or other information at block 612 to determine whether the sensor has reached its end-of life. Here, an end-of-life condition may be indicated based on the output voltage. For example, the transparency of the sensor may decrease as the sensor ages and/or is repeatedly subjected to the target gas. Thus, if the output voltage is down to, for example, approximately 20% of the original maximum output value (e.g., 0.8V for reference of 4V) when there is no CO, the sensor may be deemed to be at its end-of-life. In some embodiments a timer may be used to determine the end-of-life for the sensor.

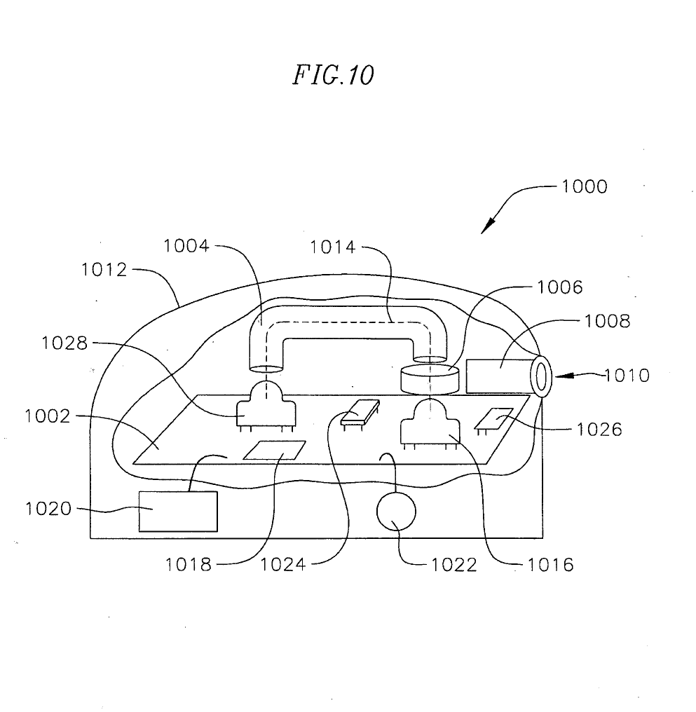

FIG. 10 is a simplified diagram of one embodiment of a sensor apparatus 1000. In the drawing a portion of the housing of the apparatus 1000 is cut away to show the internal components.

A circuit board 1002, a light guide 1004, a sensor 1006 and a filter or getter 1008 are mounted within a housing 1012. The filter/getter 1008 is mounted in a manner that enables air to pass through a port 1010 in the housing 1012, through the getter 1008 and to the sensor 1006.

The light guide 1004 is mounted within the housing 1012 such that at least a portion of the light (as represented by dashed line 1014) from an LED 1028 is coupled through the light guide 1004 to the sensor 1006. The sensor 1006 is mounted within the housing 1012 such that at least a portion of the light 1014 that passes through the sensor 1006 passes to a photodiode 1016.

The LED 1028, the photodiode 1016 and a processor 1018 may be mounted on the circuit board 1002. In addition, other components such as those discussed herein may be mounted on or attached to the circuit board 1002. For example, a display device 1020, an alarm 1022, a temperature sensor 1024, a smoke detector 1026 or other components may be mounted on or otherwise connected to the circuit board. Typically, the housing 1012 may include a hermitic seal to seal off one or more of the internal components.

It should be appreciated that a variety of components (e.g., LEDs, sensors, photodiodes, light guides, getters, processors, displays, alarms, housings and associated components) may be used to implement an apparatus as taught herein. For example, in some embodiments the LED may be an IR42-21C/TR8 infrared LED sold by Everlight Electronic Co., Ltd. In some embodiments the sensor comprises a sensor as described in U.S. Pat. Nos. 5,063,164; 5,302,350; 5,346,671; 5,405,583; 5,618,493; 5,793,295; 6,172,759; 6,251,344 and 6,819,811. Preferably the sensor will have relatively good stability to enable it to provide the desired linearity with the range of interest. In some embodiments the photodiode may be PD15-22C PIN photodiode sold by Everlight Electronic Co., Ltd. In some embodiments the light guide may be constructed of a material such as polycarbonate (e.g., Lexan 121R).

The filter or getter may remove acid gases such as sulfur dioxide, sulfur trioxide, oxides of nitrogen, and similar acid compounds from the air stream. In some embodiments a getter comprises a porous air filter mater impregnated with acid reacting chemical such as sodium bicarbonate, sodium carbonate, calcium carbonate and magnesium hydroxide. In addition, a filter section or getter may be designed to react with bases such ammonia. Getter may consist of citric acid, tartaric acid, phosphoric acid, molybdosilicic and other acids polymeric acids impregnated on silica gel or other suitable substrate. A layer of charcoal may separate the acid from the basic layer. A useful air purification system may include 4 to 5 active layers separated by inert material such as a porous felt. The air purification system is also the subject of U.S. Pat. No. 6,251,344.

FIG. 11 illustrates the use of a sensor 1110 in a combined CO and smoke detector 1100. The use of such a combination may enhance early fire detection by cross fertilization from one sensor system, such as smoke, to increase the sensitivity of the other. Fire detection devices may also incorporate other sensors such as heat, CO2, and hydrogen. An advantage to multiple-sensing fire detection is increased reliability and reduced false alarms. In one fire detection system embodiment, a photoelectric smoke sensor is combined with the smoke detector in a manner so that photons 1120 deflected or scattered 1121 by smoke particles cause less photons to strike a photodetector 1140 behind the sensor 1110. The scattered photons 1121 instead strike a dark photodetector 1125 sensor in the smoke circuit. The photons that are emitted 1120 from the photon source 1130, in the absence of any particles go directly though the sensor 1110 and the strike the light photodetector 1140 such as a photodiode. If the CO sensor starts to get dark, then the smoke circuit is sensitized.

FIG. 12 represents a schematic diagram of a combined CO/RH/T/Smoke detector/alarm device. An infrared LED 1203, red LED 1202, infrared photodiode 1204, and a wide range photodiode 1201 are mounted in a detection chamber 1200 of the device. A temperature sensor 1208 is placed outside the detection chamber, but in the alarm enclosure. The algorithm for the system is embedded in microcontroller 1207. The microcontroller is configured to receive, from the detection elements, the following four signals: smoke 1210, red LED passes 1205 through the sensor, infrared LED passes 1206 through the sensor, and temperature 1210. Software embedded into the microcontroller does the calculations between these signals and makes the decision on the status of the environment regarding the temperature (“T”), the CO level, the relative humidity (“RH”) and smoke. A rapid raise in temperature and RH is an early indication of fire. The algorithm embedded in the microcontroller will decide when and if to trigger an alarm. The algorithm includes a correlation between the four parameters in various fire situations, making this alarm respond in the fastest way.

For example, the system may use an algorithm to interpret the CO reading and adjust the smoke detector to be more sensitive when a CO is detected. The system may make further sensitivity adjustments when the level of CO increases and/or as the rate at which the CO changes increases. Conversely, when smoke is detected, the system may reduce the COHb or CO level that will initiate an alarm condition.

The device has light trapping fins that are curved so that smoke has access from all direction. This is an improvement over the CO/Smoke alarm described in U.S. Pat. No. 5,793,295 in which a dropping resistor is used to enhance the air flow through the smoke chamber with a heating chimney effect.

A fire detection system having the ability to see a rapid rise in relative humidity may provide additional advantages. Rapid rise in both RH and temperature indicated a serious combustion problem such as blocked flu or fire. When the CO and humidity detection features are combined with temperature and smoke (ions and/or smoke particles) a more reliable early warning system is obtained for fire.

A sensor apparatus as described herein may be used in a variety of products and applications. For example, the apparatus may be used in applications that utilize battery power; AC power; 12-volt low power system as well as AC with battery back up. In an example embodiment a low-power version of the apparatus may a current draw of less than 25 microamps in stand-by operation.

The sensor apparatus may be incorporated into alarm systems that communicate by wires or RF waves to a central panel. In this way, the digital CO readings may be transmitted to the central panel. At the central panel the system may process the highest level location in, for example a building. In addition the system may process the rate of increase in any measured parameters to find the source of the measured parameter and to provide information as to the movement of, for example, a fire or CO.

In addition, some embodiments may be used with vehicles such RVs or cars. For example, a portable sensor may be placed on the vehicle's visor or other locations (e.g., the dashboard or a passenger's pocket or belt) while driving. In addition, the portable unit may be easily removed for use in other locations outside the vehicle such as for CO protection in the workplace by workers and/or by contractors, fire persons, utility or other serviceperson, etc., or on forklifts and similar vehicles that do not have visors.

Portable products may be operated on common batteries that can be easily replaced. The sensor system may be replaced separately or with the battery. The most accurate detector system able to respond to less than 30 ppm CO may contain sensor(s) that need to be replaced occasionally (1 to 15 years). This is particularly important for the fuel cell controls and remote applications for fire protection.

In the case where the portable CO detection units contain a rechargeable battery, the battery may be recharged in the vehicle during operating or when used outside the vehicle. The rechargeable battery can act as battery back-up in some applications, which is also advantageous. The device should be configured so that the back-up battery can be replaced safely by isolation of any possible line power from the vehicle or other source. This can be accomplished by means of an opening for the battery that requires the unit to be disconnecting from the power in order to get access to the battery or another isolation means. Certain vehicles such as electric cars powered by fuel cells may comprise a hydrocarbon reformer to convert hydrocarbon to hydrogen, carbon dioxide and carbon monoxide. The CO sensing system may operate off of the main vehicle electric power generated by the fuel cell or other electric generation means and may also have a battery back up system. In addition to CO, humidity and temperature can be detected in some environments as it an important indoor air quality parameter.

The above CO sensor technologies may be incorporated into the small size CO detector or digital monitor. The sensors may be used, for example, in ventilation controls, medical devices fuel cells and digital monitors as well alarms.

For a case where the target gas is CO and the sensor comprises one or more sensors (e.g., each having different ranges as described in U.S. Pat. No. 6,096,560) optically responding to CO, the system may switch to the sensor with the larger range automatically. The sensor may be protected by the same humidity and air quality control method described in U.S. Pat. No. 6,251,344. By employing humidity and air quality management system, the sensors are more selective and live much longer than those with the control system.

Some embodiments relate to a method and/or apparatus for reducing noise in a sensing device. In general, signal and safety sensing devices experience electromagnetic noise and interference (EMI). For example, electromagnetic signals may interfere with alarm signals or control signals. A means to reduce the noise and/or other interference and improve the signal-to-noise ratio of the sensor may be accomplished by making all or a portion of the sensing housing conductive or more conductive. Such a conductive means around any sensing will server to reduce the potential interference and noise, for example, by reducing the noise from the sensors. A decision on whether to make a housing conductive may be made depending on the type of sensor. For example, certain types of sensors may generate more noise than other types of sensors.

The conductive means may be accomplished by implementing a portion or all of the sensing housing or another housing structure in the sensing device using conductive plastics, conductive polymers, metals, conductive-coated (e.g., metal) plastic, composite materials, a mixture thereof or other techniques. The use of conductive plastic, or a plastic coated with a thin metal, may provide a relatively low cost method to add conductivity to a non-conductive chamber that might contain one or more components of a sensing device.

In some embodiments a sensing device may reduce noise and interference from EMI by making the sensing elements conductive. The sensing device may comprise a conductive plastic sensor housing about any sensor or a metal housing or a mixture of an inert layer being insulation and an outer layer being conductive.

In some embodiments a sensing device reduces noise in the signal of an optical sensor that uses conductive plastic housing to surround the optical sensing components. The sensing device may comprise an LED and a Photodiode and a sensing element located between the photon path of the LED and the Photodiode that change its optional transmission as a function of a gas to be measured.

Various modifications and enhancements may be applied to such sensing devices. For example, in some embodiments an outer conductive layer is formed over an inner non-conductive material. In some embodiments a conductive coating is at least one metal selected from the group gold, palladium, platinum, titanium, niobium, bismuth, silver, lead, iron, nickel, copper, tin, zinc, aluminum, chromium or alloys that do not corrode easily such as solders, stainless steel, bronze, brass, and other similar alloys of magnesium and lithium, beryllium and copper, cadmium and other metal alloys. In some embodiments the sensing device comprises an electrochemical sensor that is housed in an insulating plastic and the insulating plastic is coated with a conductive material to reduce noise from electromagnetic signals.

It should be appreciated that the various components and features described herein may be incorporated in an apparatus independently of the other components and features. For example, an apparatus incorporating the teachings herein may include various combinations of these components and features. Thus, not all of the components and features described herein may be employed in every such an apparatus.

References to specific structures and processes in the disclosed embodiments should be understood to be but one example of structures and processes that may be used in these or other embodiments in accordance with the teachings provided herein. Accordingly, otherwise restrictive nomenclatures such as “is,” “are,” etc., should be understood to include less restrictive meanings such as “may be,” etc.

Different embodiments of the invention may include a variety of hardware and software processing components. In some embodiments of the invention, hardware components such as controllers, state machines and/or logic are used in a system constructed in accordance with the invention. In some embodiments code such as software or firmware executing on one or more processing devices may be used to implement one or more of the described operations.

Such components may be implemented on one or more integrated circuits. For example, in some embodiments several of these components may be combined within a single integrated circuit. In some embodiments some of the components may be implemented as a single integrated circuit. In some embodiments some components may be implemented as several integrated circuits.

The components and functions described herein may be connected/coupled in many different ways. The manner in which this is done may depend, in part, on whether the components are separated from the other components. In some embodiments some of the connections represented by the lead lines in the drawings may be in an integrated circuit and/or on a circuit board.

The signals discussed herein may take several forms. For example, in some embodiments a signal may be an electrical signal transmitted over a wire while other signals may consist of light pulses transmitted over an optical fiber.

A signal may comprise more than one signal. For example, a signal may consist of a series of signals. Also, a differential signal comprises two complementary signals or some other combination of signals. In addition, a group of signals may be collectively referred to herein as a signal.

Signals as discussed herein also may take the form of data. For example, in some embodiments an application program may send a signal to another application program. Such a signal may be stored in a data memory.

The components and functions described herein may be connected/coupled directly or indirectly. Thus, in some embodiments there may or may not be intervening devices (e.g., buffers) between connected/coupled components.

A wide variety of devices may be used to implement the data memories discussed herein. For example, a data memory may comprise RAM, ROM, flash memory, one-time-programmable (OTP) memory or other types of data storage devices.

While certain exemplary embodiments have been described above in detail and shown in the accompanying drawings, it is to be understood that such embodiments are merely illustrative of and not restrictive of the broad invention. In particular, it should be recognized that the teachings of the invention apply to a wide variety of systems and processes. It will thus be recognized that various modifications may be made to the illustrated and other embodiments of the invention described above, without departing from the broad inventive scope thereof.

For example, various types of light sources (e.g., visible light, etc.) and light detectors may be used in an apparatus constructed in accordance with the teachings herein. In addition, various types of sensors may be used and these sensors may be configured to react to a different target (e.g., other than CO) gas or vapor or toxin. For example, a sensor may be adapted to detect mercury, ethylene oxide, volatile organic materials, hydrogen sulfides, etc., as discussed, for example, in U.S. Pat. No. 5,063,164. A first derivative active circuit or other circuits may be used to directly output the slope value. The current to voltage converter could be replaced with a resistor that is placed in parallel with the photodiode such that a voltage may be read directly from the resistor. In this case, the voltage value may be read using a high impedance input of the controller in conjunction with an analog to digital converter.

In view of the above it will be understood that the invention is not limited to the particular embodiments or arrangements disclosed, but is rather intended to cover any changes, adaptations or modifications which are within the scope and spirit of the invention as defined by the appended claims.

What is claimed is:

1. An apparatus for sensing the presence of a target gas, comprising:
a photon source;
a sensor having an optical characteristic that varies in accordance with a concentration of a target gas;
a photon detector optically coupled with the sensor and the photon source to detect photons that passed from the photon source through the sensor, the photon detector being biased to generate in response to the detected photons an output signal within an operating range, such that at least one substantially linear output signal range is provided within the operating range;
an analog to digital converter coupled to the photon detector for converting the output signal to a digital output signal; and
a processor coupled to receive the digital output signal from the analog to digital converter, the processor adapted to calculate a concentration level of the target gas in accordance with the at least one substantially linear output signal range, the processor further adapted to provide at least one indication in accordance with the calculated concentration level.

2. An apparatus of claim 1, wherein the operating range is from about one to about four volts.

3. The apparatus of claim 1, wherein the at least one substantially linear output signal range comprises a plurality of linear ranges.

4. The apparatus of claim 3 wherein the processor is adapted to calculate the gas concentration using linear equations associated with the linear ranges.

5. The apparatus of claim 1, wherein the photon source comprises at least one LED and the photon detector comprises at least one photodiode.

6. The apparatus of claim 1 wherein the at least one predefined slope is associated with a rate of change of the output signal for a given value of the output signal.

7. The apparatus of claim 1 wherein the processor is a microprocessor that includes the analog to digital converter which is adapted to calculate the gas concentration using a linear equation.

8. The apparatus of claim 1 wherein the processor is adapted to calculate the gas concentration using a linear equation based on empirical measurements relating to an interdependence of output voltage, temperature and concentration of a target gas.

9. The apparatus of claim 7 wherein the processor is adapted to calculate the gas concentration using a linear equation based on at least one predefined slope associated with the output signal and the rate of change of the output signal.

10. The apparatus of claim 9 wherein the at least one predefined slope is stored in a data memory.

11. The apparatus of claim 9 wherein the at least one predefined slope comprises a plurality of slopes each of which is associated with a range of the output voltage.

12. The apparatus of claim 1 wherein the at least one predefined slope comprises one of a plurality of slopes associated with a plurality of ranges of the output signal.

13. The apparatus of claim 12 wherein each slope is an average of slopes associated with one of the ranges.

14. The apparatus of claim 1 wherein the processor is adapted to calculate the gas concentration in accordance with a compensation factor.

15. The apparatus of claim 14 wherein the compensation factor is stored in a data memory.

16. The apparatus of claim 14 wherein:
the at least one predefined slope comprises a plurality of slopes each of which is associated with a range of the output voltage; and
the at least one predefined slope is multiplied by the compensation factor.

17. The apparatus of claim 1, wherein accuracy of the apparatus is within about one percent at room temperature.

18. The apparatus of claim 1, wherein accuracy of the apparatus is within about five percent over a temperature range of about −40° C. to about 70° C.

19. The apparatus of claim 1, wherein the accuracy of the apparatus is within about thirty percent over a temperature range of about 0° C. to about 50° C. and relative humidity of about 7.5% RH to about 95% RH.
